(19) United States
(12) Patent Application Publication
(10) Pub. No.: US 2009/0304914 A1
(43) Pub. Date: Dec. 10, 2009

(54) Self assembled monolayer for improving adhesion between copper and barrier layer

(75) Inventors: Praveen Nalla, Fremont, CA (US); William Thie, Mountain View, CA (US); John Boyd, Hillsboro, OR (US); Tiruchirapalli Arunagiri, Fremont, CA (US); Hyungsuk Alexander Yoon, San Jose, CA (US); Fritz C. Redeker, Fremont, CA (US); Yezdi Dordi, Palo Alto, CA (US)

Correspondence Address: MARTINE PENILLA & GENCARELLA, LLP, 710 LAKEWAY DRIVE, SUITE 200, SUNNYVALE, CA, 94085, US

(73) Assignee: Lam Research Corporation, Fremont, CA (US)

(21) Appl. No.: 11/639,012

(22) Filed: Dec. 13, 2006

Related U.S. Application Data
(63) Continuation-in-part of application No. 11/514,038, filed on Aug. 30, 2006.

(51) Int. Cl. B05D 3/10

(52) U.S. Cl. 427/124; 427/123; 118/695

(57) ABSTRACT

The embodiments fill the need enabling deposition of a thin and conformal barrier layer, and a copper layer in the copper interconnect with good electro-migration performance and with reduced risk of stress-induce voiding of copper interconnect. Electromigration and stress-induced voiding are affected by the adhesion between the barrier layer and the copper layer. A functionalization layer is deposited over the barrier layer to enable the copper layer being deposit in the copper interconnect. The functionalization layer forms strong bonds with barrier layer and with copper to improve adhesion property between the two layers. An exemplary method of preparing a substrate surface of a substrate to deposit a functionalization layer over a metallic barrier layer of a copper interconnect to assist deposition of a copper layer in the copper interconnect in order to improve electromigration performance of the copper interconnect is provided. The method includes depositing the metallic barrier layer to line the copper interconnect structure in the integrated system, and oxidizing a surface of the metallic barrier layer. The method also includes depositing the functionalization layer over the oxidized surface of the metallic barrier layer, and depositing the copper layer in the copper interconnect structure after the funcationalization layer is deposited over the metallic barrier layer.

### CLAIM OF PRIORITY

This application is a continuation in part of U.S. application Ser. No. 11/514,038 (Attorney Docket No. LAM2P568B), titled “Processes and Systems for Engineering A Barrier Surface for Copper Deposition,” filed on Aug. 30, 2006.

### CROSS REFERENCE TO RELATED APPLICATION

This application is related to U.S. patent application Ser. No. ______ (Attorney Docket No. LAM2P578) filed on the same date as this application, entitled “Methods and Apparatus for Barrier Interface Preparation of Copper Interconnect.” The disclosure of this related application is incorporated herein by reference in its entirety for all purposes.

### BACKGROUND

Integrated circuits use conductive interconnects to wire together the individual devices on a semiconductor substrate, or to communicate externally to the integrated circuit. Interconnect metallization for vias and trenches may include aluminum alloys and copper. As device geometry continues to scale down to 45-nm-node technology and sub-45-nm technology, the requirement of continuous barrier/seed layer with good step coverage in high aspect-ratio geometry features to enable void free copper filling becomes challenging. The motivation to go to ultra thin and conformal barrier in 45-nm-node or sub-45-nm-technology is to reduce the barrier's impact on via and line resistance. However, poor adhesion of copper to the barrier layer could cause delamination between the barrier layer and copper during processing or thermal stressing that poses a concern on electro-migration and stress-induced voiding.

In view of the foregoing, there is a need for methods and apparatus that enable deposition of a thin and conformal barrier layer, and a copper layer in the copper interconnect with good electro-migration performance and with reduced risk of stress-induce voiding of copper interconnect.

### SUMMARY

Broadly speaking, the embodiments fill the need enabling deposition of a thin and conformal barrier layer, and a copper layer in the copper interconnect with good electro-migration performance and with reduced risk of stress-induce voiding of copper interconnect. Electromigration and stress-induced voiding are affected by the adhesion between the barrier layer and the copper layer. A functionalization layer can be deposited over the barrier layer to enable the copper layer being deposit in the copper interconnect. The functionalization layer forms strong bonds with barrier layer and with copper to improve adhesion property between the two layers. It should be appreciated that the present invention can be implemented in numerous ways, including as a solution, a method, a process, an apparatus, or a system. Several inventive embodiments of the present invention are described below.

In one embodiment, a method of preparing a substrate surface of a substrate to deposit a functionalization layer over a metallic barrier layer of a copper interconnect to assist deposition of a copper layer in the copper interconnect in order to improve electromigration performance of the copper interconnect is provided. The method includes depositing the metallic barrier layer to line the copper interconnect structure in the integrated system, and oxidizing a surface of the metallic barrier layer. The method also includes depositing the functionalization layer over the oxidized surface of the metallic barrier layer, and depositing the copper layer in the copper interconnect structure after the functionalization layer is deposited over the metallic barrier layer.

In another embodiment, a method of preparing a substrate surface of a substrate to deposit a functionalization layer over a metallic barrier layer of a copper interconnect to assist deposition of a copper layer in the copper interconnect in order to improve electromigration performance of the copper interconnect is provided. The method includes depositing the metallic barrier layer to line the copper interconnect structure in the integrated system. The method also includes depositing the functionalization layer over the oxidized surface of the metallic barrier layer. The method further includes depositing the copper layer in the copper interconnect structure after the functionalization layer is deposited over the metallic barrier layer.

In another embodiment, an integrated system for processing a substrate in controlled environment to enable deposition of a functionalization layer over a metallic barrier layer of a copper interconnect to improve electromigration performance of the copper interconnect is provided. The integrated system includes a lab-ambient transfer chamber capable of transferring the substrate from a substrate cassette coupled to the lab-ambient transfer chamber into the integrated system, and a vacuum transfer chamber operated under vacuum at a pressure less than 1 Torr. The integrated system also includes a vacuum process module for depositing the metallic barrier layer, wherein the vacuum process module for depositing the metallic barrier layer is coupled to the vacuum transfer chamber, and is operated under vacuum at a pressure less than 1 Torr. The integrated system further includes a controlled-ambient transfer chamber filled with an inert gas selected from a group of inert gases, and a deposition process module used to deposit the functionalization layer on the surface of the metallic barrier layer.

Although the invention is described in terms of enabling a Cu dual-Damascene interconnect process, it can also be applied to through-hole vias used in 3 dimensional (or 3D) packaging or personal computer board (PCB) process schemes. Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A-1D show cross sections of a dual-damascene interconnect structure at various stages of interconnect processing.

FIGS. 2A-2C show cross sections of a metal line structure at various stages of interconnect processing.

FIGS. 3A-3C shows cross sections of a metal line structure at various stages of interconnect processing to incorporate a functionalization layer.

FIG. 3D shows a schematic diagram of bondings between one end of a functionalization layer with a tantalum oxide surface and between another end of a functionalization layer with copper.

FIG. 3E shows a cross section of deposited layer of an interconnect structure.

FIG. 3F shows the complexing group of a functionalization layer deposited on the oxidized metallic barrier surface at an angle α.

FIG. 4 show a cross section of a non-formal barrier layer deposited in an opening of an interconnect structure.

FIGS. 5A-5E show cross sections of an interconnect structure at various stages of interconnect processing to incorporate a functionalization layer.

FIG. 6A shows an exemplary process flow of interconnect processing that incorporates a functionalization layer.

FIG. 6B shows an exemplary integrated system used to process a substrate using a process flow of FIG. 6A.

### DETAILED DESCRIPTION OF THE EXEMPLARY EMBODIMENTS

Several exemplary embodiments for improved metal integration techniques that add an adhesion-promoting layer to improve interface adhesion are provided. It should be appreciated that the present invention can be implemented in numerous ways, including a process, a method, an apparatus, or a system. Several inventive embodiments of the present invention are described below. It will be apparent to those skilled in the art that the present invention may be practiced without some or all of the specific details set forth herein.

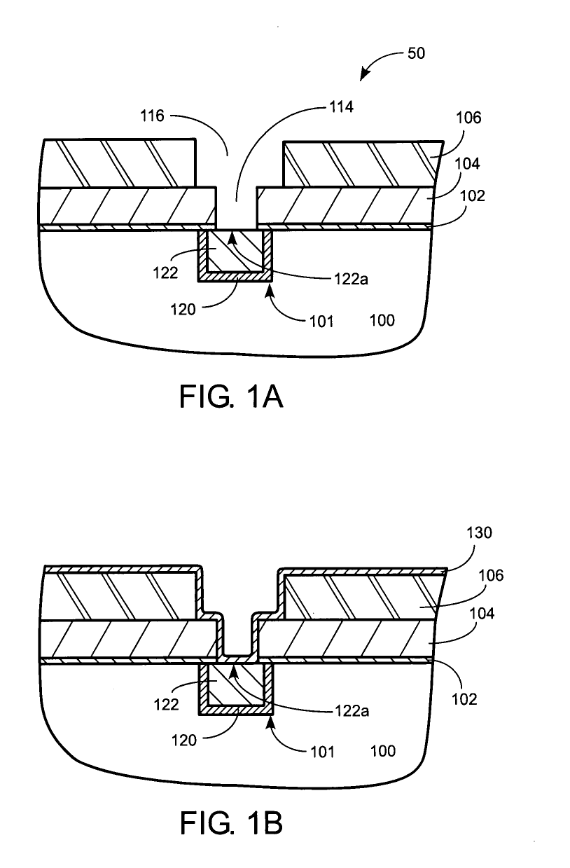

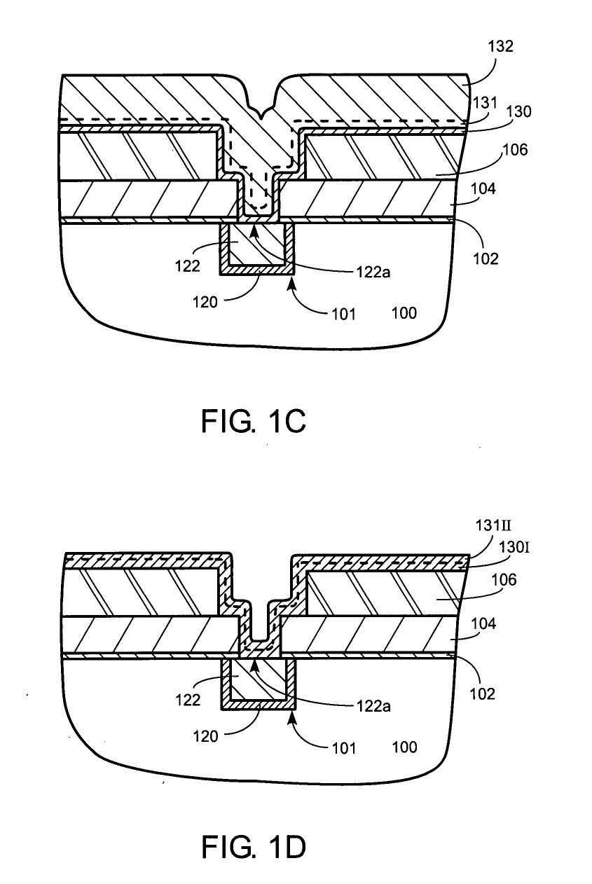

FIG. 1A shows an exemplary cross-section of an interconnect structure(s) after being patterned by using a dual damascene process sequence. The interconnect structure(s) is on a substrate 50 and has a dielectric layer 100, which was previously fabricated to form a metallization line 101 therein. The metallization line is typically fabricated by etching a trench into the dielectric 100 and then filling the trench with a conductive material, such as copper.

In the trench, there is a barrier layer 120, used to prevent the copper material 122, from diffusing into the dielectric 100. The barrier layer 120 can be made of physical vapor deposition (PVD) tantalum nitride (TaN), PVD tantalum (Ta), atomic layer deposition (ALD) TaN, or a combination of these films. Other barrier layer materials can also be used. A barrier layer 102 is deposited over the planarized copper material 122 to protect the copper material 122 from premature oxidation when via holes 114 are etched through overlying dielectric materials 104, 106 to the barrier layer 102. The barrier layer 102 is also configured to function as a selective etch stop. Exemplary barrier layer 102 materials include silicon nitride (Si₃N₄) silicon carbo-nitride (SiCN), or silicon carbide (SiC).

A via dielectric layer 104 is deposited over the barrier layer 102. The via dielectric layer 104 can be made of an organo-silicate glass (OSG, carbon-doped silicon oxide) or other types of dielectric materials, preferably with low dielectric constants. Exemplary silicon dioxides can include, a PECVD un-doped TEOS silicon dioxide, a PECVD fluorinated silica glass (FSG), a HDP FSG, OSG, porous OSG, etc. and the like. Commercially available dielectric materials including Black Diamond (I) and Black Diamond (II) by Applied Materials of Santa Clara, Calif., Coral by Novellus Systems of San Jose, Aurora by ASM America Inc. of Phoenix, Ariz., can also be used. Over the via dielectric layer 104 is a trench dielectric layer 106. The trench dielectric layer 106 may be a low K dielectric material, such as a carbon-doped oxide (C-oxide). The dielectric constant of the low K dielectric material can be about 3.0 or lower. In one embodiment, both the via and trench dielectric layers are made of the same material, and deposited at the same time to form a continuous film. After the trench dielectric layer 106 is deposited, the substrate 50 that holds the structure(s) undergoes patterning and etching processes to form the vias holes 114 and trenches 116 by known art.

FIG. 1B shows that after the formation of vias holes 114 and trenches 116, a barrier layer 130 and a copper layer 132 are deposited to line and fill the via holes 114 and the trenches 116. The barrier layer 130 can be made of tantalum nitride (TaN), tantalum (Ta), Ruthenium (Ru), or a hybrid combination of these materials. While these are the commonly considered materials, other barrier layer materials can also be used. Barrier layer materials may be other refractory metal compound including but not limited to titanium (Ti), tungsten (W), zirconium (Zr), hafnium (Hf), molybdenum (Mo), niobium (Nb), vanadium (V), ruthenium (Ru), iridium (Ir), platinum (Pt), and chromium (Cr), among others.

A copper film 132 is then deposited to fill the via holes 114 and the trenches 116, as shown in FIG. 1C. In one embodiment, the copper film 132 includes a thin copper seed layer 131 underneath. In another embodiment, the thickness of the thin copper seed layer is between about 5 angstroms to about 300 angstroms.

Barrier layers, such as Ta, TaN or Ru, if exposed to air for extended period of time, can form metal oxide, such as, TaₓO_{y} (Tantalum oxide), TaOₓN_{y} (Tantalum oxynitride), or RuO₂ (Ruthenium oxide). Metal oxide, such as TaₓO_{y}, TaOₓN_{y}, or RuO₂ can also be formed when the barrier metal, such as Ta, TaN, or Ru, is exposed to water aqueous solutions. Electroless deposition of a metal layer on a substrate is highly dependent upon the surface characteristics and composition of the substrate. Electroless plating of copper on a Ta, TaN, or Ru surface is of interest for both conformal seed layer formation prior to electroplating, and selective deposition of Cu lines within lithographically defined pattern(s). One concern is the inhibition of the electroless deposition process by atomically thin native metal oxide layer formed in the presence of oxygen (O₂) or aqueous solutions.

In addition, copper films do not adhere well to the barrier oxide layer, such as tantalum oxide, tantalum oxynitride, or ruthenium oxide, as well as it adheres to the pure barrier metal or barrier-layer-rich film, such as Ta, Ru, or Ta-rich TaN film. Ta and/or TaN barrier layers are only used as examples. The description and concept apply to other types of barrier metals, such as Ta or TaN capped with a thin layer of Ru. As described above, poor adhesion can negatively affect the EM performance and stress-induced voiding. Due to these issues, it is desirable to use the integrated system to prepare the barrier/copper interface to ensure good adhesion between the barrier layer and copper and to ensure low resistivity of the barrier-layer/copper stack.

FIG. 1B shows that the barrier layer 130 is a single layer deposited either by ALD or PVD. Alternatively, the barrier layer 130 can be deposited by an ALD process to deposit a first barrier layer 130_{I}, such as TaN, which is followed by a PVD second barrier layer 130_{II}, such as Ta, as shown in FIG. 1D.

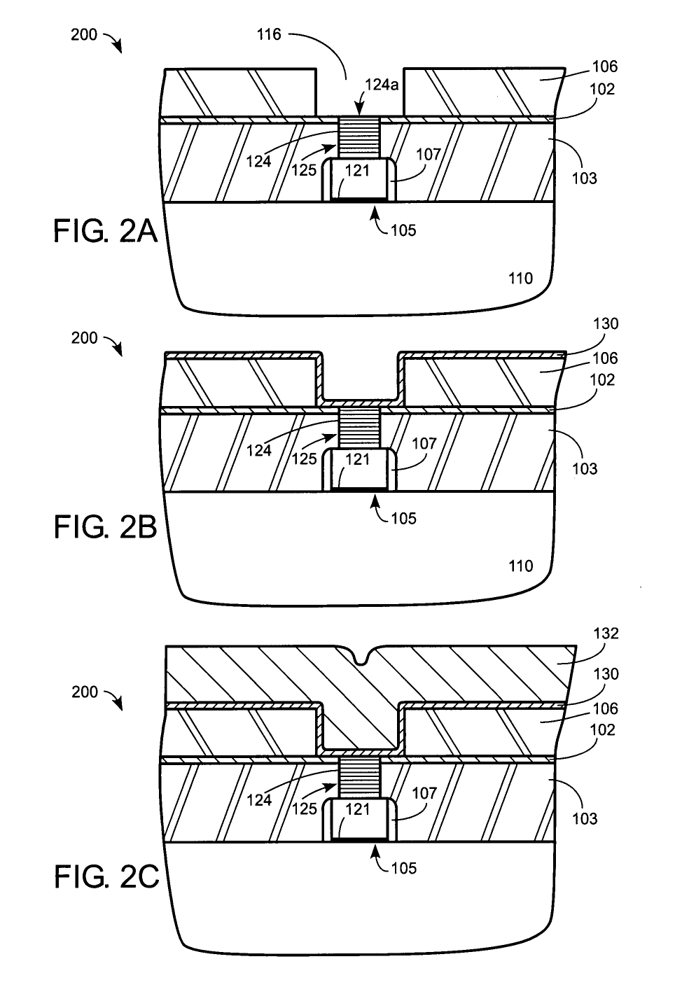

In addition to dual-damascene interconnect structures, copper interconnect can also be applied to metal lines (or M1 lines) over contacts. FIG. 2A shows an exemplary cross-section of a metal line structure after being patterned by a dielectric etch and being removed of photoresist. The metal line structure(s) is on a substrate 200 and has a silicon layer 110, which was previously fabricated to form a gate structure 105 with a gate oxide 121, spacers 107 and a contact 125 therein. The contact 125 is typically fabricated by etching a contact hole into the oxide 103 and then filling the contact hole with a conductive material, such as tungsten. Alternative materials may include copper, aluminum or other conductive materials. The barrier layer 102 is also configured to function as a selective trench etch stop. The barrier layer 102 can be made of materials such as silicon nitride (Si₃N₄), silicon carbo-nitride (SiCN), or silicon carbide (SiC).

A metal line dielectric layer 106 is deposited over the barrier layer 102. The dielectric materials that can be used to deposit 106 have been described above. After the deposition of dielectric layer 106, the substrate is patterned and etched to create metal trenches 106. FIG. 2B shows that after the formation of metal trenches 116, a metallic barrier layer 130 is deposited to line metal trench 116. FIG. 2C shows that after the barrier layer 130 is deposited, a copper layer 132 is deposited over the barrier layer 130. Similar to the dual-damascene interconnect structures, the barrier layer 130 can be made of materials, such as tantalum nitride (TaN), tantalum (Ta), ruthenium (Ru), or a combination of these films. A copper film 132 is then deposited to fill the metal trench 116.

As described above for dual-damascene structures, barrier layer, such as Ta, TaN or Ru, if exposed to air or aqueous solution for extended period of time, can form TaₓO_{y} (Tantalum oxide), TaOₓN_{y} (Tantalum oxynitride), or RuO₂ (Ruthenium oxide), which affects the quality of adhesion between copper and the barrier layer. In one embodiment, chemical-grafting compounds that would selectively bond to the oxidized barrier metal surface to form a self-assembled monolayer (SAM) of such chemicals on the oxidized barrier metal surface. The chemical-grafting chemicals have two ends. One end bonds to the oxidized barrier metal surface and the other end forms bonds with copper. The monolayer of the chemical-grafting compounds, through the strong bonding on one end with the oxidized barrier metal and the other end with copper, allow copper to adhesion securely to the copper interconnect structure. The good adhesion of copper to the interconnect structure improves EM performance and reduced stress-induced voiding.

The electro-grafting or chemical-grafting compound, which is a complexing group and forms a monolayer on the oxidized barrier metal surface, functionalizes the substrate surface to be deposited with a layer of material, such as copper, over the monolayer with strong bonding between the monolayer and the deposited layer material. Therefore, the monolayer can also be called a functionalization layer. From hereon, the terms self-assembled monolayer and functionalization layer are used interchangeably. The complexing group has one end that forms a covalent bond with the oxidized barrier layer surface, and another end which contains a functional group that can either bond directly with Cu, or can be modified to a catalytic site that will bond with copper. Using Ta as an example of barrier metal for copper interconnect, the complexing group of the funcationalization layer has one end forming a strong bond with TaₓO_{y} and another end forming a strong bond with copper. For SAM formed by chemical grafting, in one embodiment, the chemical-grafting molecules are adsorbed by physisorption and chemisorption from a solution (a wet process) onto solid substrates to bond with the surface and to form an ordered molecular functionalization layer, which is a self-assembled monolayer. Alternatively, the chemically-grafted compound can also be applied to the substrate surface as a vapor (a dry process).

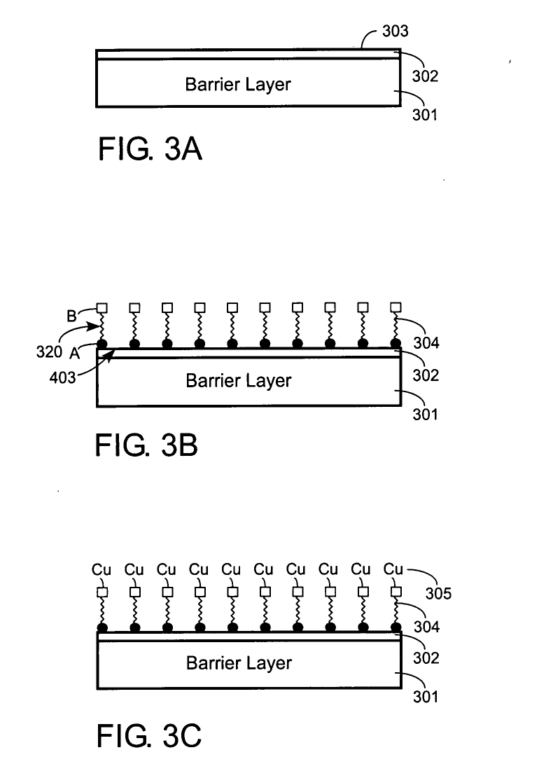

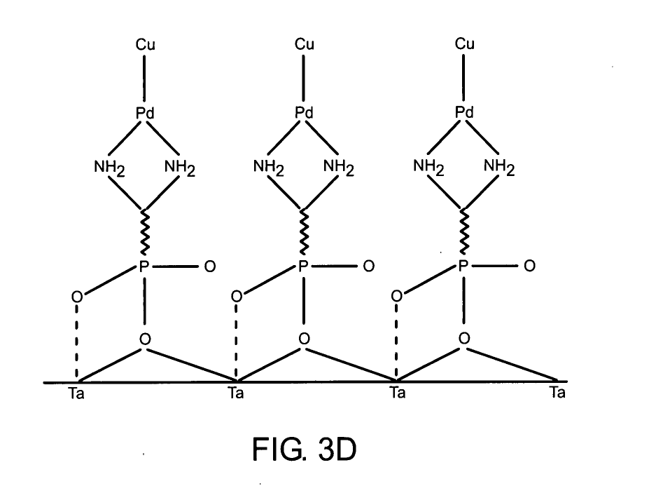

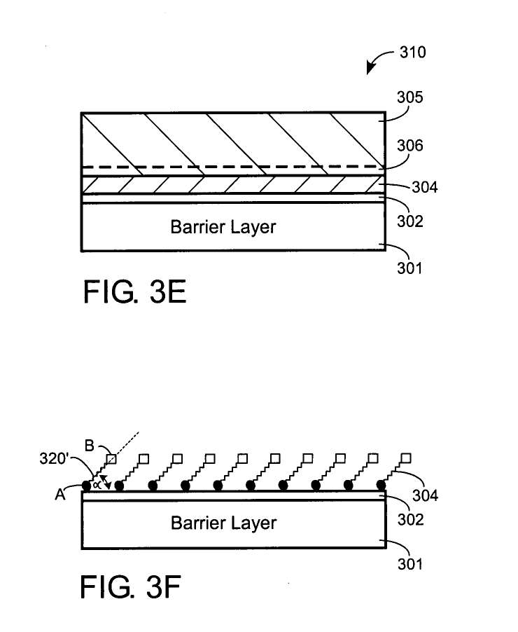

FIG. 3A shows a barrier layer 301 with a thin layer of barrier metal oxide 302 with a surface 303. FIG. 3B shows that the surface 303 is deposited with a functionalization layer 304 of the chemical-grafting complexing group 320. The complexing group 320 has two ends, A end and B end. A end forms a covalent bond with the barrier metal oxide 302. The complexing group 320 should have an A end that would form a covalent bond with the barrier metal oxide surface, which could be made of materials, such as TaₓO_{y} (Tantalum oxide), TaOₓN_{y} (Tantalum oxynitride), or RuO₂ (Ruthenium oxide). For example, phosphate (PO4-) of an alky phosphate can bond with TaₓO_{y} (such as Ta₂O₅). Other groups (radical or/and ionic) for bonding to the TaₓO_{y}, TaOₓN_{y} or RuO2 surface include silicon (—Si—), Silane (Si(OR)₃ where R═H and/or CₓH_{y}, and acid or acid chlorides (—O—CO—R).

The B end of the complexing group 320 forms a covalent bond with copper of a copper seed layer 305, as shown in FIG. 3C. The B end of the complexing group 320 should be composed of a compound that would form a covalent bond with copper. The B end of the complexing group 320 may be metallic or organometallic in nature, or have conductive properties (such as conductive polymers) to enable electroless deposition of copper directly on the barrier surface upon which has been deposited the functionalization layer. Examples of the compound that would form a metallic bond with copper include Ru-pyridine, Pd-amine (palladium-amine), Pd-pyridine, Cu-pyridine, Cu-amine, and Ru-amine, S—Au. Acetate linkage with metal here would also include chelation complexes of di, tri, tetra, and penta acetate groups. The bond between the Ru or Pd or Au or Cu metals (the catalyst) with the functional groups (in this case e.g. pyridine, amine, thiol, nitrile, acid or acetate), is the semi-covalent or donor bond. The bond between the catalyst metal and the Cu seed is metallic bond. The complexing group has the general form of PO4-R′—R, wherein PO4- is the A end that bonds with TaₓO_{y} and R is the B end that bonds with copper.

FIG. 3D shows a complexing group with a phosphate (PO₄—) on the A end and a palladium-amine (Pd-amine) on the B end. The phosphate bonds to the TaₓO_{y} surface, while copper bonds to Pd.

FIG. 3E shows a cross section of an interconnect stack 310. A thin barrier metal oxide layer 302 has grown on the surface of a barrier layer 301. A functionalization mono-layer 304 is deposited over the thin barrier metal oxide layer 302. The functionalizational mono-layer bonds firmly to the thin barrier metal oxide layer 302. One end of the complexing group of the functionalization layer 304 bonds with the barrier metal oxide. Over the functionalization layer 304, a copper layer 305 is deposited. In one embodiment, the copper layer 305 includes a copper seed layer 306. Copper in the copper layer 305 bonds to the other end of the complexing group of the functionalization layer 304. Since the bonds between the functionalization layer and the barrier surface, which is a barrier metal oxide, and between the functionalization layer and copper are covalent bonds, the copper is securely attached to barrier layer 301 through the functionalization layer 304 and the barrier metal oxide layer 302. The interconnect stack 310 could be inside a via hole 114 or a metal trench 116 of FIG. 1A.

The complexing group of the functionalization mono-layer 304 shown in FIGS. 3B and 3C appears to be linear and positioned perpendicularly to the substrate surface. However, the complexing group could be positioned non-perpendicularly to the substrate surface. FIG. 3F shows an example of a complexing group 320′ positioned at an angle α less than 90° from the substrate surface. When the complexing group 320′ is attached to the substrate surface at an angle α, the thickness of the functionalization mono-layer is less than when the complexing group is attached to the substrate surface perpendicularly. The thickness (T) approximately equals to the product of the sine of the angle θ of the monolayer to the substrate and the length (L) of the molecules (T=L*sine[θ]).

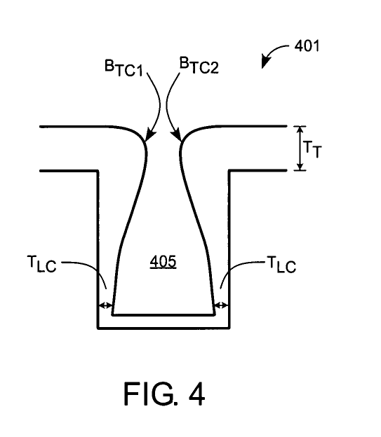

To apply a functionalization layer to improve adhesion between the barrier layer and copper layer for 45 nm technology node or sub-45 nm technology nodes, such as 22 nm node, the barrier layer 301 with its accompanying barrier metal oxide layer 302 should be as thin as possible. FIG. 4 shows an interconnect structure 401, which could be a via hole or a metal trench. A barrier layer 403 is deposited in the opening 405. If the barrier deposition process is a physical vapor deposition (PVD), the thickness T_{T} of the barrier film on top surface of the structure 401 could be 10 times the thickness T_{LC} of the barrier layer thickness at the lower corners (or bottom corners) of the structure. PVD process normally has poor step coverage and the barrier film on the top corners B_{TC} and B_{TC} can come in contact before the barrier layer is filled from the bottom, which leaves a key hole in the interconnect structure 401. Key holes in the interconnect structures can trap chemicals used in the gapfill process, causing corrosion or explosive vaporization during low pressure, high temperature processes after planarization, or can be opened up during metal CMP and trap contamination inside to reduce yield; therefore formation of key holes should be avoided. As a result, the thickness of the barrier layer should be kept as thin as possible and the barrier film should be as conformal as possible. Using a functionalizational mono-layer sandwiched between the barrier layer and the copper layer reduces the size of the opening available to deposit a copper layer. Therefore, the functionalizational monolayer should be kept as thin as possible. In one embodiment, the thickness of the functionalization layer is between about 10 angstroms to about 30 angstroms. In addition, the functionalization layer should not significantly increase overall metal line resistance, or via resistance. In the case of a through-hole via process for 3D packaging applications, the presence of the monolayer will have negligible impact on the resistivity of the metal in the via, and will not contribute to the via resistance at all.

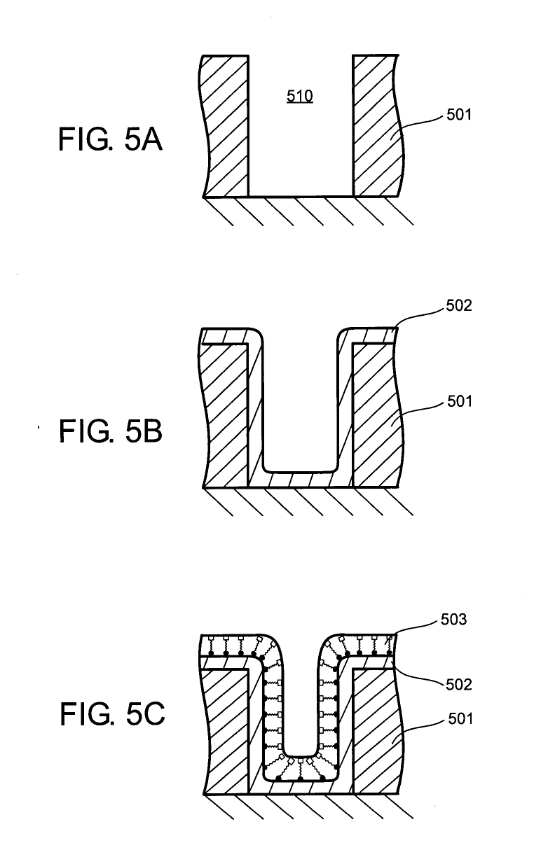

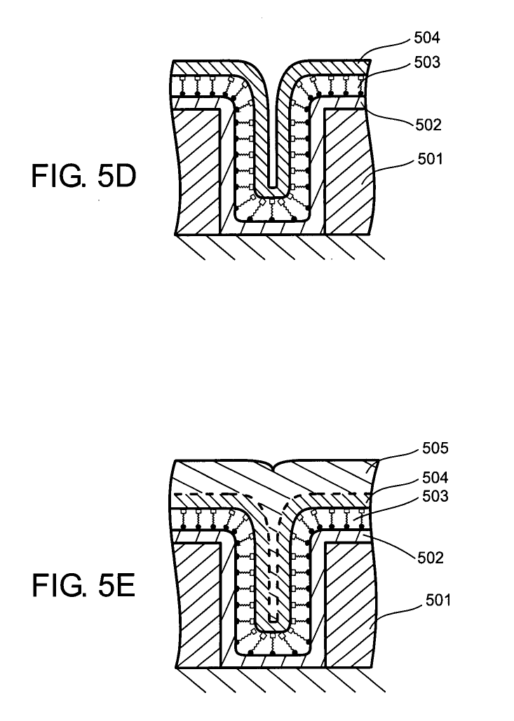

FIG. 5A shows an opening 510 of an interconnect metal trench structure (metal 1) that is surrounded by a dielectric layer 501. FIG. 5B shows that a barrier layer 502 is deposited to line the metal trench opening 510. The bottom of the metal structure is a contact, which is similar to the contact 125 shown in FIG. 2A-2C. The barrier layer can be deposited by ALD, PVD, or other applicable processes. The thickness of the barrier layer is between about 5 angstroms to about 300 angstroms. FIG. 5C shows that a functionalizational monolayer 503 of chemical-grafting complexing compound is deposited on barrier layer 502. After the functionalizational monolayer 503 is deposited, a copper seed layer 504 is deposited over the functionalizational monolayer 503, as shown in FIG. 5D. After copper seed layer 504 is deposited, copper gap-fill layer 505 is deposited, as shown in FIG. 5E.

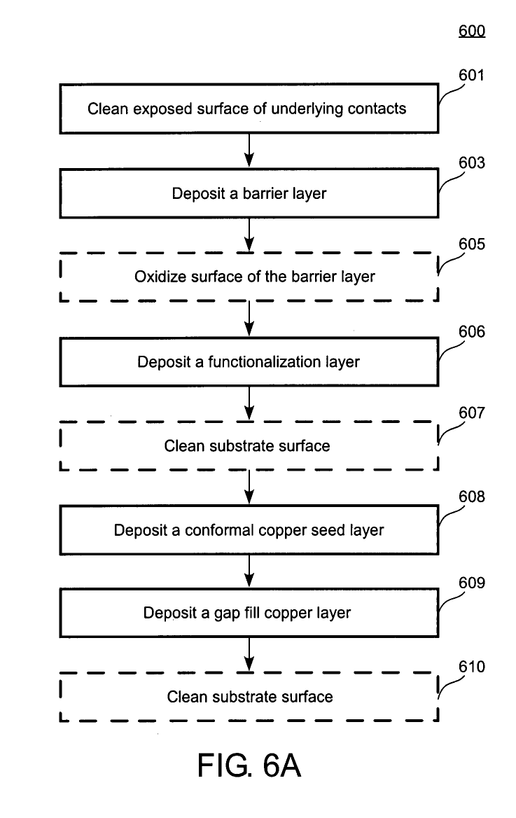

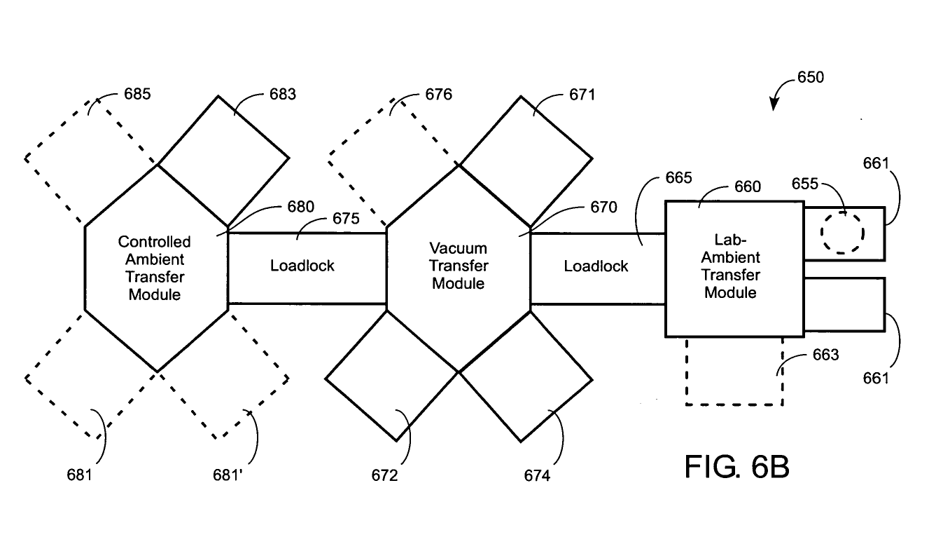

FIG. 6A shows an embodiment of a process flow of preparing the barrier (or liner) layer surface for electroless copper deposition. At step 601, the top surface 125a of contact 125 of FIG. 2A is cleaned to remove native metal oxide. Metal oxide can be removed by an Ar sputtering process, a plasma process using a fluorine-containing gas, such as NF₃, CF₄, or a combination of both, a wet chemical etch process, or a reduction process, for example using a hydrogen-containing plasma. Metal oxide can be removed by a wet chemical removal process in a 1-step or a 2-step wet chemical process sequence. The wet chemical removal process can use an organic acid, such as DeerClean offered by Kanto Chemical Co., Inc. of Japan or a semi-aqueous solvent, such as ESC 5800 offered by DuPont of Wilmington, Del., an organic base such as tetramethylammonium chloride (TMAH), complexing amines such as ethylene diamine, diethylene triamine, or proprietary chemistry such as ELD clean and Cap Clean 61, provided by Enthone, Inc. of West Haven, Conn. In addition, metal oxides, specifically copper oxide, can be removed using a weak organic acid such as citric acid, or other organic or inorganic acids can be used. Additionally, very dilute (i.e. <0.1%) peroxide-containing acids, such as sulfuric-peroxide mixtures, can also be used. At step 603, a barrier layer is deposited in either an ALD or a PVD system.

As described above, for the functionalization layer to be properly deposited on the barrier surface, the barrier surface should be covered by barrier oxide. The barrier layer is treated by an oxidizing ambient, such as an oxygen-containing plasma, a controlled thermal oxygen treatment, or a wet chemical treatment with peroxide or other oxidizing chemicals, at step 605 to produce a barrier-metal oxide layer that will enable the subsequent functionalization layer deposition step.

The oxidizing treatment is optional, depending on the composition of the surface. Afterwards, the substrate surface is deposited with a SAM of chemical-grafting complexing compound at step 606. In one embodiment, the chemical-grafting complexing compound is mixed in a solution and the deposition process is a wet process. An optional clean step 607 after the deposition step at 606 may be needed.

Afterwards, a conformal copper seed is deposited on the barrier surface at step 608, followed by a thick copper bulk fill (or gap fill) process, 609. The conformal copper seed layer can be deposited by an electroless process. The thick copper bulk fill (also gap fill) layer can be deposited by an ECP process. Alternatively, the thick bulk fill (also gap fill) layer can be deposited by an electroless process in the same electroless system for conformal copper seed, but with a different chemistry. Optionally, if a thiol-containing ligand is used as the ‘B’ end group, gold nanoparticles can be deposited to form catalytic sites for the subsequent copper deposition step.

After the substrate is deposited with conformal copper seed at step 608, and thick Cu bulk fill by either an electroless or electroplating process at step 609, the next process step 610 is an optional substrate-cleaning step to clean any residual contaminants from the previous deposition.

FIG. 6B shows an embodiment of a schematic diagram of an integrated system 650 that enables copper interconnect processing to produce copper interconnect with good electromigration and with reduced stress-induced voiding. The integrated system 650 can be used to process substrate(s) through the entire process sequence of flow 600 of FIG. 6A.

The integrated system 650 has 3 substrate transfer modules 660, 670, and 680. Transfer modules 660, 670 and 680 are equipped with robots to move substrate 655 from one process area to another process area. The process area could be a substrate cassette, a reactor, or a loadlock. Substrate transfer module 660 is operated under lab ambient. Module 660 interfaces with substrate loaders (or substrate cassettes) 661 to bring the substrate 655 into the integrated system or to return the substrate to one of the cassettes 661.

As described above in process flow 600 of FIG. 6A, the substrate 655 is brought to the integrated system 650 to deposit barrier layer, to prepare barrier surface for copper layer deposition. As described in step 601 of process flow 600, top contact surface 125a of contacts 125 is etched to remove native metal oxide. Once the metal oxide is removed, the exposed metal surface 125a of FIG. 2A needs to be protected from exposure to oxygen. Since system 650 is an integrated system, the substrate is transferred from one process station immediately to the next process station, which limits the duration that clean metal surface 125a is exposed to low levels of oxygen.

If the removal process is an Ar sputtering process, the Ar sputtering reactor 671 is coupled to the vacuum transfer module 670. If a wet chemical etching process is selected, the reactor should be coupled to the controlled-ambient transfer module 680, not the lab-ambient transfer module 660, to limit the exposure of the clean tungsten surface to oxygen. For a wet process to be integrated in a system with controlled processing and transporting environment, the reactor needs to be integrated with a rinse/dryer to enable dry-in/dry-out process capability. In addition, the system needs to be filled with inert gas to ensure minimal exposure of the substrate to oxygen.

Afterwards, the substrate is deposited with the barrier layer. The barrier layer 130 of FIG. 2B can be deposited by a PVD or an ALD process. In one embodiment, the barrier layer 130 is deposited by an ALD process, which is a dry process and is operated at less than 1 Torr. The ALD reactor 672 is coupled to the vacuum transfer module 670. The substrate can undergo an optional surface oxidization process to ensure the barrier layer surface is metal-oxide-rich for functionalization layer deposition. The oxidation reactor 674 can be coupled to the vacuum transfer module 670. At this stage, the substrate is ready for chemical-grafting complexing compound functionalizational monolayer deposition. As described above, in one embodiment, this process is a wet process and can be deposited in a chemical-grafting complexing compound deposition chamber 683, coupled to the controlled-ambient transfer module 680. In one embodiment, chamber 683 is integrated a cleaning module (not shown) to clean the substrate 655 after the functionalizational monolayer deposition. In another embodiment, the deposition of the functionalization monolayer is performed in a dry process reactor 676, which is coupled to the vacuum transfer module 670. The reactor is operated under 1 Torr. In one embodiment, substrate 655 undergoes an optional substrate cleaning step 607, as described in process flow 600. The substrate cleaning process can be a brush clean process, whose reactor 685 can be integrated with the controlled-ambient transfer module 680. After the substrate surface cleaning, substrate 655 is ready for copper seed layer deposition, as described in step 608 of flow 600. In one embodiment, the copper seed layer deposition is performed by an electroless process. The electroless copper plating can be performed in an electroless copper plating reactor 681 to deposit a conformal copper seed layer, as described in step 608 of FIG. 6A. As described above, the deposition of the gap fill copper layer at step 609 of FIG. 6A can be deposited in the same electroless plating reactor 681 with different chemistry, or in a separate ECP reactor 681′.

Before the substrate leaves the integrated system 650, the substrate can optionally undergoes a surface cleaning process, which can clean residues from the previous copper plating process. The substrate cleaning process can be brush clean process, whose reactor 663 can be integrated with the lab-ambient transfer module 660.

The wet processing systems described in FIG. 6B, which are coupled to the controlled-ambient transfer module 680, all need to meet the requirement of dry-in/dry-out to allow system integration. In addition, the systems are filled with one or more inert gases to ensure minimal exposure of the substrate to oxygen.

The process flow 600 described in FIG. 6A and system 650 described in FIG. 6B can be used to deposit barrier layer and copper for dual damascene structures, as shown in FIGS. 1A-1D. For dual damascene structures, step 601 in flow 600 is replaced by cleaning top surface of metal line, which is shown as surface 122a of FIG. 1A.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention. In the claims, elements and/or steps do not imply any particular order of operation, unless explicitly stated in the claims.

1. A method of preparing a substrate surface of a substrate to deposit a functionalization layer over a metallic barrier layer of a copper interconnect to assist deposition of a copper layer in the copper interconnect in order to improve electromigration performance of the copper interconnect in an integrated system, comprising:
depositing the metallic barrier layer to line the copper interconnect structure in the integrated system,
oxidizing a surface of the metallic barrier layer;
depositing the functionalization layer over the oxidized surface of the metallic barrier layer; and
depositing the copper layer in the copper interconnect structure after the functionalization layer is deposited over the metallic barrier layer.

2. The method of claim 1, wherein the material of the metallic barrier layer is selected from the group consisting of tantalum nitride (TaN), tantalum (Ta), Ruthenium (Ru), titanium (Ti), tungsten (W), zirconium (Zr), hafnium (Hf), molybdenum (Mo), niobium (Nb), vanadium (V), and chromium (Cr), and a hybrid combination of these materials.

3. The method of claim 1, wherein the material used for the functionalization layer comprises a complexing group with at least two ends, one end of the complexing group forming a bond with the oxidized surface of the metallic barrier layer and another end of the complexing group forming a bond with copper.

4. The method of claim 3, wherein the end of the complexing group that forming a bond with oxidized surface of the metallic barrier layer is selected from the group consisting of phosphate (PO₄₋), silicon, silane (—Si(OR)₃, and acid or acetate (—O—CO—R), R being H or CₓH_{y}.

5. The method of claim 3, wherein the end of the complexing group forming a bond with copper is metallic or organometallic and is selected from the group consisting of Ru-pyridine, Pd-amine (palladium-amine), Pd-pyridine, Cu-pyridine, Cu-amine, Ru-amine, Ru-acetate, Cu-acetate and Pd-acetate.

6. The method of claim 3, wherein the end of the complexing group forming a bond with copper is a thiol-containing ligand, gold nanoparticles being deposited to form catalytic sites for the subsequent copper deposition step.

7. The method of claim 1, wherein oxidizing the surface of the metallic barrier layer is performed by an oxidizing ambient.

8. The method of claim 1, further comprising:
cleaning an exposed surface of a underlying metal to the copper interconnect to remove a surface metal oxide of the exposed surface of the underlying metal before depositing the metallic barrier layer, wherein the underlying metal is part of an underlying interconnect electrically connected to the copper interconnect.

9. The method of claim 1, wherein the copper interconnect include a metal line over a via and the copper interconnect is over an underlying interconnect which includes a metal line.

10. The method of claim 1, wherein the copper interconnect include a metal line and the copper interconnect is over an underlying interconnect which includes a contact.

11. The method of claim 1, wherein the copper interconnect includes a through-hole via in a 3 dimensional (3D) packaging or personal computer board (PCB).

12. The method of claim 1, wherein depositing the metallic barrier layer further comprising:
depositing a first metallic barrier layer; and
depositing a second metallic barrier layer.

13. The method of claim 12, wherein the first metallic barrier layer is deposited by an atomic layer deposition (ALD) process and the second metallic barrier layer is deposited by a physical vapor deposition (PVD) process.

14. The method of claim 12, wherein the first metallic barrier layer is deposited by an ALD process and the second metallic barrier layer is deposited by an ALD process.

15. The method of claim 1, further comprising:
cleaning a surface of the functionalization layer in the integrated system before depositing the copper layer.

16. The method of clam 1, wherein the copper layer is deposited by an electroless process.

17. The method of claim 1, wherein the copper layer is deposited by an electrochemical plating (ECP) process.

18. The method of claim 1, wherein depositing the metallic barrier layer, oxidizing the surface of the metallic barrier layer, depositing the functionalization layer, and depositing the copper layer are performed in an integrated system.

19. A method of preparing a substrate surface of a substrate to deposit a functionalization layer over a metallic barrier layer of a copper interconnect to assist deposition of a copper layer in the copper interconnect in order to improve electromigration performance of the copper interconnect in an integrated system, comprising:
depositing the metallic barrier layer to line the copper interconnect structure in the integrated system,
depositing the functionalization layer over the oxidized surface of the metallic barrier layer; and
depositing the copper layer in the copper interconnect structure after the functionalization layer is deposited over the metallic barrier layer.

20. An integrated system for processing a substrate in controlled environment to enable deposition of a functionalization layer over a metallic barrier layer of a copper interconnect to improve electromigration performance of the copper interconnect, comprising:
a lab-ambient transfer chamber capable of transferring the substrate from a substrate cassette coupled to the lab-ambient transfer chamber into the integrated system;
a vacuum transfer chamber operated under vacuum at a pressure less than 1 Torr;
a vacuum process module for depositing the metallic barrier layer, wherein the vacuum process module for depositing the metallic barrier layer is coupled to the vacuum transfer chamber, and is operated under vacuum at a pressure less than 1 Torr;
a controlled-ambient transfer chamber filled with an inert gas selected from a group of inert gases; and
a deposition process module used to deposit the functionalization layer on the surface of the metallic barrier layer, wherein the deposition process module is coupled to the controlled-ambient transfer chamber.

21. The integrated system of claim 20, further comprising:
an electroless copper deposition process module used to deposit a thin layer of copper seed layer in the copper interconnect after the functionalization layer is deposited on the surface of the metallic barrier layer, wherein the electroless copper deposition process module is coupled to the controlled-ambient transfer chamber.

22. The integrated system of claim 20, further comprising:
an oxidation process module used to oxidize a surface of the metallic barrier layer before the functionalization layer is deposited on the surface of the metallic barrier layer, wherein the oxidation process module is coupled to the vacuum transfer chamber and is operated under vacuum at a pressure less than 1 Torr.

23. The integrated system of claim 21, wherein the electroless copper deposition process module is also used to deposit a gap-fill copper layer over the thin copper seed layer.

24. The integrated system of claim 21, further comprising:
an electroless copper deposition process module to deposit a gap-fill copper layer over the thin copper seed layer.

25. The integrated system of claim 20, further comprising:
a substrate cleaning process module used to clean the substrate surface after depositing the functionalization layer over the metallic barrier layer, wherein the substrate cleaning process module is coupled to the controlled-ambient transfer module.

26. The integrated system of claim 20, wherein the deposition process module used to deposit the functionalization layer is a wet process module and is coupled to the controlled-ambient transfer module.

27. The integrated system of claim 20, wherein the deposition process module used to deposit the functionalization layer is a dry process module and is coupled to vacuum transfer module.

28. The integrated system of claim 20, further comprising:
a first loadlock coupled to the vacuum transfer chamber and the controlled-ambient transfer chamber, wherein the first loadlock assists the substrate to be transferred between the vacuum transfer chamber and the controlled-ambient transfer chamber, the first loadlock being configured to be operated under vacuum at pressure less than 1 Torr or to be filled with an inert gas selected from a group of inert gases; and
a second loadlock coupled to the vacuum transfer chamber and the lab-ambient transfer chamber, wherein the second loadlock assists the substrate to be transferred between the vacuum transfer chamber and the lab-ambient transfer chamber, the second loadlock being configured to be operated under vacuum at pressure less than 1 Torr or at lab ambient or to be filled with an inert gas selected from a group of inert gases.

29. The integrated system of claim 20, wherein the vacuum transfer chamber and the vacuum process module coupled to the vacuum transfer chamber are operated at a pressure less than 1 Torr to control the exposure of the substrate to oxygen.

30. The integrated system of claim 20, wherein the controlled-ambient transfer chamber and the deposition process module coupled to the controlled-ambient transfer chamber are filled with one or more inert gases selected from the group of inert gases to control the exposure of the substrate to oxygen.

31. The integrated system of claim 20, wherein the at least one process module coupled to the controlled-ambient transfer module enables a dry-in/dry-out processing of the substrate, wherein the substrate goes in and comes out the at least one process module in a dry state.

32. The integrated system of claim 20, wherein the oxidation process module prepares the surface of the metallic barrier layer to be deposited with the functionalization layer.
